(19) United States
(12) Patent Application Publication
(10) Pub. No.: US 2011/0121568 A1
(43) Pub. Date: May 26, 2011

(54) Swellable connection system and method of using the same

(75) Inventor: Laurence James Abney, Sandnes (NO)

(73) Assignee: HALLIBURTON ENERGY SERVICES, INC., Houston, TX (US)

(21) Appl. No.: 12/622,995

(22) Filed: Nov. 20, 2009

(51) Int. Cl. F16L 13/14

(52) U.S. Cl. 285/382.4

(57) ABSTRACT

A method of making a connection in hydrocarbon production equipment comprising positioning at least a portion of a receiving component about at least a portion of an insertable component, providing a swellable element within a circumferential space substantially defined by the at least a portion of the receiving component and the at least a portion the insertable component, and allowing the swellable element to expand. A hydrocarbon production equipment apparatus comprising an insertable component positioned within a receiving component, and a swellable element positioned between at least a portion of the insertable component and at least a portion of the receiving component, wherein the insertable component, the receiving component, or both is coupled to a hydrocarbon production equipment member, wherein the swellable element swells in response to contact with a swelling agent.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A subterranean formation or zone beneath a body of water may serve as a source and/or a storage location for a natural resource such as hydrocarbons or water and/or for the disposal of carbon dioxide or other material. The recovery of hydrocarbons, for example oil or gas, from a subterranean formation beneath a body of water presents challenges in addition to those encountered when seeking to recover hydrocarbons from a subterranean formation elsewhere. These additional challenges encountered in drilling, completion, production, injection, and post-production operations may be difficult, time-consuming, and expensive.

For example, drilling, completion, production, injection, and post-production operations may require that several of various types of connections be made between various types or pieces of subsea hydrocarbon production or servicing equipment. Many of these connections may be made at a substantial depth within the body of water below a drilling platform, production platform, or other surface vessel, thereby increasing the difficulty in making such a connection. For example, it may be necessary to connect various tubular members, such as pipeline members or riser members, to each other, to a platform, to various other subsea hydrocarbon production equipment (e.g., a subsea wellhead or template), or combinations thereof. Additionally, for example, it may be necessary to connect tethering members or cables to each other, to anchoring devices, to the platform, or combinations thereof. In still another, example, it may be necessary to make a connection around a tubular member, pipeline, riser, or the like which is believed to be of compromised integrity. Conventionally, methods of making such connections have employed expensive and complicated devices to make reliable, strong, and/or fluid-tight seals. Therefore, there exists a need for improved methods, systems, and apparatuses for making a subsea connection.

### SUMMARY

Disclosed herein is a method of making a connection in hydrocarbon production equipment comprising positioning at least a portion of a receiving component about at least a portion of an insertable component, providing a swellable element within a circumferential space substantially defined by the at least a portion of the receiving component and the at least a portion the insertable component, and allowing the swellable element to expand.

Also disclosed herein is a hydrocarbon production equipment apparatus comprising an insertable component positioned within a receiving component, and a swellable element positioned between at least a portion of the insertable component and at least a portion of the receiving component, wherein the insertable component, the receiving component, or both is coupled to a hydrocarbon production equipment member, wherein the swellable element swells in response to contact with a swelling agent.

Further disclosed herein is a hydrocarbon production equipment apparatus comprising a first collar positioned about a first tubular member, a second collar configured to be positioned about a second tubular member, the second tubular member generally coaxially aligned with the first tubular member and spaced apart from the first tubular member to form a gap between the first and second tubular members, a first swellable element positioned between at least a portion of the first tubular member and at least a portion of the first collar, wherein the first swellable element contacts the first collar and the first tubular member upon contact with a swelling agent, a second swellable element positioned between at least a portion of the second tubular member and at least a portion of the second collar, wherein the second swellable element contacts the second collar and the second tubular member upon contact with the swelling agent, and a sleeve coupled to the first collar and the second collar and enclosing the gap between the first and second tubular members.

Further disclosed herein is a hydrocarbon production equipment apparatus wherein the first tubular member, the second tubular member, the first swellable element, the second swellable element, and the sleeve are located subsea.

### BRIEF DESCRIPTION OF THE DRAWINGS

FIG. 1 is an illustration of a typical working environment for one or more embodiments of a swellable connection or method of using the same.

FIG. 2 is an illustration of an embodiment of a swellable connection being made.

FIG. 3A is a cut-away view of a tubular connection system, prior to a male tubular end being positioned with respect to a female tubular end and prior to expansion of a swellable element.

FIG. 3B is a cut-away view of a tubular connection system, following a male tubular end being positioned with respect to a female tubular end and prior to expansion of a swellable element.

FIG. 3C is a cut-away view of a tubular connection system, following a male tubular end being positioned with respect to a female tubular end and following expansion of a swellable element.

FIG. 4A is a cut-away view of a riser hang-off system, prior to a riser being positioned with respect to a platform T Tube and prior to expansion of a swellable element.

FIG. 4B is a cut-away view of a riser hang-off system, following a riser being positioned with respect to a platform T tube and prior to expansion of a swellable element.

FIG. 4C is a cut-away view of a riser hang-off system, following a riser being positioned with respect to a platform T tube and following expansion of a swellable element.

FIG. 5A is a cut-away view of a platform tether system, following a male tether end being positioned with respect to a female tether end and prior to expansion of a swellable element.

FIG. 5B is a cut-away view of a platform tether system, following a male tether end being positioned with respect to a female tether end and following expansion of a swellable element.

FIG. 6A is a cut-away view of a tubular repair system, following a tubular member being positioned with respect to two sealing collars and prior to expansion of one or more swellable elements.

FIG. 6B is a cut-away view of a tubular repair system, following a tubular member being positioned with respect to two sealing collars and following expansion of one or more swellable elements.

### DETAILED DESCRIPTION

In the drawings and description that follow, like parts are typically marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness.

Unless otherwise specified, use of any form of the terms “connect,” “engage,” “couple,” “attach,” or any other term describing an interaction between elements is not meant to limit the interaction to direct interaction between the elements and may also include indirect interaction between the elements described.

Unless otherwise specified, use of the terms “up,” “upper,” or “upward,” shall mean generally toward the surface of the subsea and use of the terms “down,” “lower,” “downward,” or “downhole” shall mean generally toward the sea floor.

The various characteristics mentioned above, as well as other features and characteristics described in more detail below, will be readily apparent to those skilled in the art with the aid of this disclosure upon reading the following detailed description of the embodiments, and by referring to the accompanying drawings.

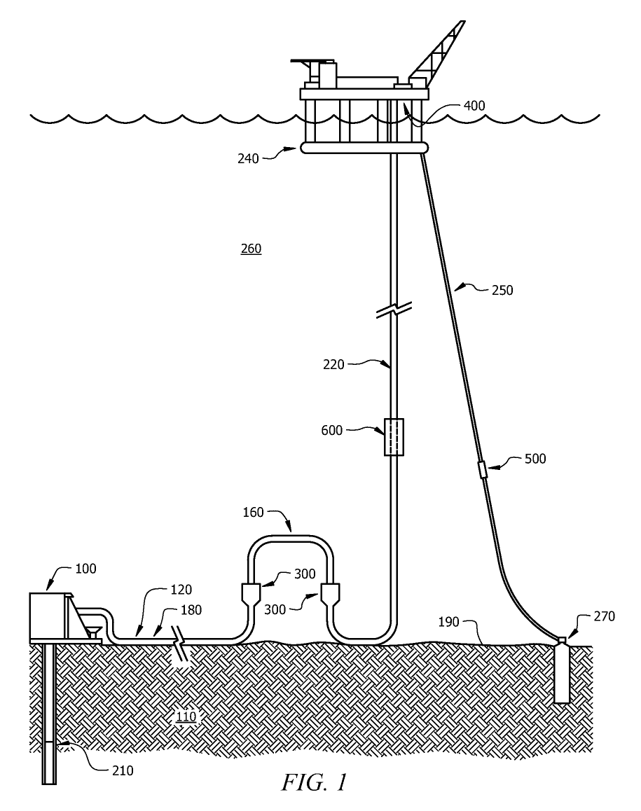

Referring to FIG. 1, an exemplary operating environment of a connection system is shown. While the connection system is shown and described specifically with regard to certain embodiments, various other embodiments of connection systems consistent with the teachings herein are described infra. As depicted, the operating environment comprises a wellbore 210 penetrating a subterranean formation 110 beneath a body of water 260 for the purpose of recovering and/or storing hydrocarbons, water, and/or carbon dioxide. The wellbore 210 may be drilled into the subterranean formation 110 using any suitable drilling technique. The wellbore 210 may extend substantially vertically beneath the body of water 260 over a vertical wellbore portion or may deviate at any angle from the earth's surface over a deviated or horizontal wellbore portion. In various operating environments, all or portions of the wellbore may be vertical, deviated, horizontal, and/or curved. Various subsea equipment employed in the production and/or storage of hydrocarbons, water, and/or carbon dioxide, referred to herein cumulatively as “hydrocarbon production equipment,” may comprise various tubular members, for example, a riser 220 which extends through the body of water 260 below a platform 240 (e.g., a drilling and/or production vessel or platform). The riser 220 may extend substantially vertically beneath the platform 240 to a point where the riser 240 is connected to further subsea hydrocarbon production equipment. The subsea hydrocarbon production equipment may further comprise other various tubular members, for example, a pipeline 180 extending along the sea floor 190. The pipeline 180 may extend substantially horizontally between a riser and a point where a manifold or the wellbore 210 penetrates the subterranean formation 110, e.g., pipeline end template, manifold, or wellhead 100. Alternatively, a riser such as riser 220 may be connected directly to a wellhead. The subsea hydrocarbon production equipment may extend in any suitable direction, at substantially any angle from the surface of the body of water 260, and to any suitable depth within the body of water 260. The subsea hydrocarbon production equipment may comprise one or more pipeline end template, manifold or wellheads 100, one or more risers 220, one or more pipelines 180, associated hydrocarbon production equipment (e.g., flow couplings, pipeline joints, landing nipples, circulating devices, pumps, valves, mandrels, travel joints, cross-over joints), and combinations thereof. The subsea hydrocarbon production equipment may terminate at the platform 240, thereby providing fluid communication between the pipeline end template, manifold or wellhead 100 and/or the wellbore 210 and the platform 240.

The platform 240 may be held in place via one or more tethers 250. A tether may extend from the platform to an anchoring device (e.g., suction pile 270). The subsea hydrocarbon production equipment may comprise other such components as will be described herein in greater detail as well as various components known to one of skill in the art.

As shown in FIG. 1, in an embodiment, it is necessary to make a connection between two or more of the various hydrocarbon production equipment members. For example and as will be discussed in greater detail, FIG. 1 illustrates various connection systems, for example, a tubular connection system 300, a platform connection system 400, a tether connection system 500, and tubular repair system 600.

In an embodiment, the connection systems, devices, and/or methods of making such connections disclosed herein may suitably be employed to connect two or more subsea hydrocarbon production equipment members. The connection systems, devices, and methods may suitably be employed for use with or as a part of oil and/or gas production or servicing equipment. Nonlimiting examples of such members as may be suitably connected via the connection systems, devices, and/or methods include flow couplings, flow conduits, pipeline joints, pipeline connectors, spool connectors, landing nipples, circulating devices, pumps, valves, mandrels, travel joints, cross-over joints, risers, platform tethers, and the like.

In embodiments, the connection system disclosed herein generally comprises at least one receiving component, an insertable component, and at least one swellable element. In various embodiments, the insertable component, the receiving component, or both may be generally cylindrical in shape. In alternative embodiments, the insertable component, the receiving component, or both comprise any suitable shape. Suitable shapes and configurations will be appreciated by one of skill in the art with the aid of this disclosure.

In an embodiment, the insertable component is complementary to the receiving component. For example, the insertable component or a portion thereof may be configured to be positioned within at least some portion of the receiving component and thereby create a space extending between the inner surface of the receiving component and the outer surface of the insertable component, referred to herein as the “circumferential space.” Generally the circumferential space may be substantially defined by at least some portion of an inner surface of the receiving component and at least a portion of the outer surface of the insertable component.

In an embodiment, as will be discussed in greater detail herein, the insertable component will comprise a suitable outside diameter and the receiving component will comprise a suitable inside diameter. As used herein, a diameter generally refers to a dimension within a cross-sectional plane perpendicular to a longitudinal axis of the connection system. As used herein, “outside diameter” refers to a dimension twice the distance from the outer surface of a component to the center of a component and “inside diameter” refers to a dimension twice the distance from the inner surface of a component to the center of a component.

In an embodiment, the insertable component, the receiving component, flanges, or combinations thereof may be constructed of a suitable material. Materials for the construction of such components are generally known to one of skill in the art. Non-limiting examples of such materials include various metals such as titanium, iron, chromium, nickel, and alloys thereof, such as steel, stainless steel, high chrome steels, martensitic stainless steel, austenitic stainless steel, and duplex stainless steel. In an additional embodiment, the materials may comprise a composite material, for example, thermoplastic graphite fiber, carbon fiber, or combinations thereof.

In an embodiment, the swellable element may generally be positioned within the circumferential space. When caused to swell (e.g., expand), the swellable element may swell to contact at least a portion of the inner surface of the receiving component and at least some portion of the outer surface of the insertable component. The swelling (e.g., expansion) of the swellable element may cause the swellable element to contact and/or exert a force against at least a portion of the outer surface of the insertable component, at least a portion of the inner surface of the receiving component, or both. In an embodiment, the swelling of the swellable element results in a frictional force between the swellable element and the insertable component, the swellable element and the receiving component, or both. In an embodiment, such a frictional force may resist, impede or prohibit movement of the swellable element with respect to the insertable component, the receiving component, or both. In an embodiment, the frictional force between the swellable element and the insertable component and between the swellable element and the receiving component may resist, impede or prohibit movement of the insertable component with respect to the receiving component. As such, the swellable element may be employed to connect the insertable component to the receiving component.

In an embodiment, the swellable element may expand to fill, alternatively, to substantially fill, the circumferential space. It is to be understood that although a swellable element make undergo a minor and/or insignificant change in volume upon contact with a liquid or fluid other than the swelling agent with which that swellable element was designed to interact, such minor changes in volume are not referred to herein with discussions referencing swelling or expansion of a swellable element. Such minor and insignificant changes in volume are usually no more than about 5% of the original volume.

In an embodiment, the swellable element is formed from a swellable material. Alternatively, in an embodiment the swellable element comprises a swellable material fully or partially contained within a protective enclosure, housing, coating, or bladder, being permeable to the swelling agent and/or to other liquids.

In an embodiment, the swellable material may comprise a solid or semi-solid material or particle which undergoes a reversible, alternatively, an irreversible, volume change upon exposure to a swelling agent (a resilient, volume changing material). Nonlimiting examples of suitable such resilient, volume changing materials include natural rubber, elastomeric materials, styrofoam beads, polymeric beads, or combinations thereof. Natural rubber includes rubber and/or latex materials derived from a plant. Elastomeric materials include thermoplastic polymers that have expansion and contraction properties from heat variances. Other nonlimiting examples of suitable elastomeric materials include styrene-butadiene copolymers, neoprene, synthetic rubbers, vinyl plastisol thermoplastics, or combinations thereof. Nonlimiting examples of suitable synthetic rubbers include nitrile rubber, butyl rubber, polysulfide rubber, EPDM rubber, silicone rubber, polyurethane rubber, or combinations thereof. In some embodiments, the synthetic rubber may comprise rubber particles from processed rubber tires (e.g., car tires, truck tires, and the like). The rubber particles may be of any suitable size for use in a wellbore fluid. An example of a suitable elastomeric material is employed by Halliburton Energy Services in Duncan, Oklahoma in the Easywell wellbore isolation system.

In an embodiment, the swelling agent comprises an aqueous fluid, alternatively, a substantially aqueous fluid, as will be described herein in greater detail. In an embodiment, a substantially aqueous fluid comprises less than about 50% of a nonaqueous component, alternatively less than about 45%, 40%, 35%, 30%, 25%, 20%, 15%, 10%, 5%, 4%, 3%, 2% or 1% of a nonaqueous component. In an embodiment, the swelling agent may further comprise an inorganic monovalent salt, multivalent salt, or both. A non-limiting example of such a salt includes sodium chloride. The salt or salts in the swelling agent may be present in an amount ranging from greater than about 0% by weight to a saturated salt solution. That is, the water may be fresh water or salt water. In an embodiment, the swelling agent comprises seawater.

In an alternative embodiment, the swelling agent comprises a hydrocarbon. In an embodiment, the hydrocarbon may comprise a portion of one or more non-hydrocarbon components, for example less than about 50% of a non-hydrocarbon component, alternatively less than about 45%, 40%, 35%, 30%, 25%, 20%, 15%, 10%, 5%, 4%, 3%, 2% or 1% of a non-hydrocarbon component. Nonlimiting examples of such a hydrocarbon include crude-oil, diesel, natural gas, and combinations thereof. Other such suitable hydrocarbons will be known to one of skill in the art.

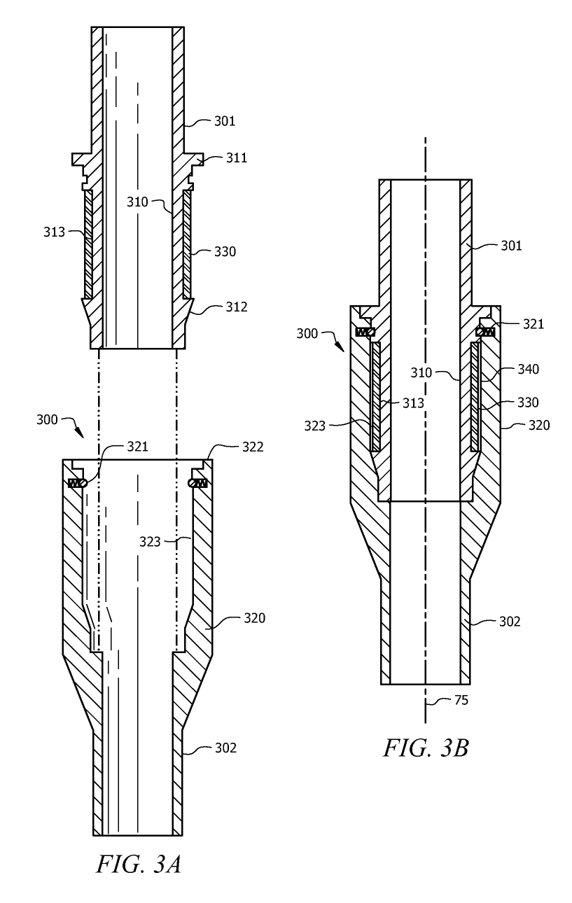

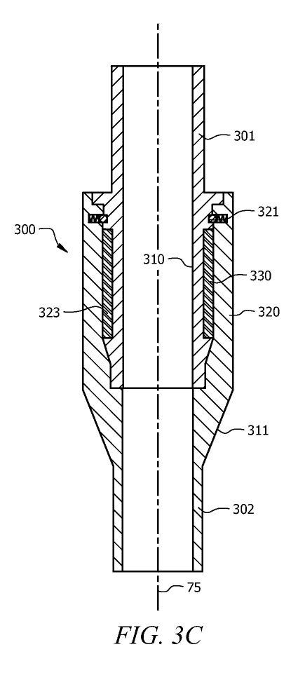

Referring now to FIGS. 3A, 3B, and 3C, in an embodiment, the connection system comprises a tubular connection system 300. In an embodiment, the tubular connection system 300 forms a connection between a first tubular member 301, a second tubular member 302, and a swellable element 330. Alternatively, a tubular connection system such as tubular connection system 300 may suitably form a connection between a tubular member and a subsea hydrocarbon production equipment member. Non-limiting examples of such tubular members or subsea hydrocarbon production equipment members as may be suitably connected by a tubular connection system include a riser; a pipeline; a flowline, a flow coupling, a pipeline joint, a landing nipple, a circulating device, a pump, a valve, a mandrel, a travel joint, a cross-over joint, the like, and combinations thereof.

In the embodiment of FIGS. 3A, 3B, and 3C, the insertable component comprises a male tubular end 310. The male tubular end 310 may be configured to be inserted within the receiving component. In the embodiment of FIGS. 3A, 3B, and 3C, the male tubular end 310 is generally cylindrical. The male tubular end may comprise an exterior surface 313, generally referring to the outer substantially cylindrical surface extending the length of the male tubular end 310.

In the embodiments of FIGS. 3A, 3B, and 3C, a male tubular end 310 comprises a segment of the first tubular member 301. In such an embodiment, the male tubular end 310 may be manufactured in conjunction with the first tubular member 301 or formed from a segment of the first tubular member 301. In an alternative embodiment, a male tubular end 310 comprises a separate unit of manufacture which may be joined to the first tubular member 301 by any suitable means which will be known to one of skill in the art (e.g., as by a threaded connection or a welded connection).

In an embodiment, a male tubular end 310 may comprise any suitable outside diameter, as will be discussed in greater detail herein. In the embodiment of FIGS. 3A, 3B, and 3C, the outside diameter of the male tubular end 310 is substantially the same of the outside diameter of the first tubular member 301. Alternatively, in embodiments the outside diameter of a male tubular end may be less than the outside diameter of a first tubular member, alternatively, greater than the outside diameter of a first tubular member.

In the embodiments of FIGS. 3A, 3B, and 3C, the male tubular end 310 is shown comprising an optional collar or flange, referred to herein as flange 311, which generally comprises a raised border extending above at least a portion of the exterior surface 313 of the male tubular end 310 and generally positioned toward or adjacent to the terminal end of the male tubular end 310. When present, the flange 311 may be attached to the male tubular end 310 by any suitable means (e.g., a welded connection or threaded connection) or formed as an integral part of male tubular end 310.

In the embodiments of FIGS. 3A, 3B, and 3C, the male tubular end 310 is shown comprising an optional beveled edge 312. As will be discussed in greater detail herein, the beveled edge 312 may aid in positioning the male tubular end 310 with respect to the receiving component and/or the swellable element 330. In an additional embodiment, the beveled edge 312 may act as a sealing face when engaging the receiving component.

In the embodiment of FIGS. 3A, 3B, and 3C, the receiving component comprises a female tubular end 320. The female tubular end 320 may be configured to receive the insertable component (e.g., the male tubular end 310). In the embodiment of FIGS. 3A, 3B, and 3C, the female tubular end 320 is generally cylindrical. The female tubular end 320 may comprise an interior surface 323, generally referring to the surface substantially defining the elongated inner bore of the female tubular end 320.

In an embodiment, a female tubular end 320 may comprise any suitable inside diameter, as will be discussed in greater detail herein. In the embodiment of FIGS. 3A, 3B, and 3C, the inside diameter of the female tubular end 320 is greater than the same of the outside diameter of the second tubular member 302. In alternative embodiments, the inside diameter of a female tubular end 320 may be less than the outside diameter of a second tubular member, alternatively, substantially the same as the outside diameter of a second tubular member.

In the embodiments of FIGS. 3A, 3B, and 3C, as was similarly discussed with respect to the male tubular end 310, the female tubular end 320 is shown comprising an optional flange 321, which may comprise a recessed portion (e.g., a channel or groove). In such an embodiment, a biasing member and assembly (e.g., a spring-loaded assembly) may be disposed therein and may hold and/or participate in holding the male tubular end 310 in place with respect to the female tubular end 320 once inserted the male tubular end 310 is inserted within the female tubular end 320. In an alternative embodiment, the flange 321 may comprise a raised border extending above least a portion of the interior surface 323 of the female tubular end 320 and generally positioned toward or adjacent to the terminal end of the female tubular end 320. When present, the flange may be attached to the female tubular end 320 by any suitable means (e.g., a welded connection or threaded connection) or formed as an integral part of the female tubular end 320. In the embodiments of FIGS. 3A, 3B, and 3C, the female tubular end 320 is shown comprising an optional beveled edge 322. As will be discussed in greater detail herein, the beveled edge 322 may aid in positioning the female tubular end 320 with respect to the male tubular end 310 and/or the swellable element 330.

Referring now to FIG. 3B, the male tubular end 310 is shown positioned within the female tubular end 320. The male tubular end 310 may be complementary to the female tubular end 320 (e.g., such that the male tubular end 310 may be inserted within the female tubular end 320). In this embodiment, a circumferential space 340 is shown extending between the exterior surface 330 of the swellable element of the male tubular end 310 and the interior surface 323 of the female tubular end 320. Also shown in FIG. 3B, the swellable element 330 in its unswollen state, which will be discussed in greater detail herein, is positioned within the circumferential space 340. Thus, as will be appreciated by one of skill in the art, in an embodiment the outside diameter of the male tubular end 310 (with reference to longitudinal axis 75) may be less than the inside diameter of the female tubular end 320 (with reference to longitudinal axis 75). Further, in an embodiment the outside diameter of the male tubular end 310 (with reference to longitudinal axis 75) is smaller than the inside diameter of the female tubular end 320 (with reference to longitudinal axis 75) (e.g. such that the unswollen swellable element 330 may be positioned within the circumferential space 340). Further still, in an embodiment the outside diameter of the flange 311 of the male tubular end 310 is smaller than or about equal to the inside diameter of the flange 321 of the female tubular end 320 (with reference to longitudinal axis 75) (e.g. such that the unswollen swellable element 330 may be positioned within the circumferential space 340).

In an embodiment, the swellable element 330 will swell when allowed to contact a swelling agent. Upon contact with the swelling agent, the swellable element 330 may expand in one or more dimensions. Not seeking to be bound by theory, the swelling agent may be adsorbed and/or absorbed by the swellable element 330, thereby causing the swellable element 330 to increase in size, volume, density, or combinations thereof.

In embodiments, the swellable element 330 may expand laterally, longitudinally, or combinations thereof with reference to the longitudinal axis 75. In the embodiments of FIGS. 3A, 3B, and 3C, the swellable element 330 is substantially sleeve-like in shape. When contacted the swelling agent, the inner diameter of the sleeve-like swellable element 330 may contract, the outer diameter of the sleeve-like swellable element 330 may expand, the swellable element 330 may elongate, or combinations thereof. In an embodiment, a swellable element may swell to a volume of about 110% of its unswollen volume, alternatively, 120%, 140%, 160%, 180%, 200%, 225%, 250%, or 300% of its unswollen volume. In embodiments, a swellable element will be generally configured to be positioned between the insertable component and the receiving component. In the embodiment of FIGS. 3A, 3B, and 3C, the swellable element 330 is configured to be positioned about at least some portion of the exterior surface 313 of the male tubular end 310 prior to positioning the male tubular end 310 with respect to the female tubular end 320 (e.g., prior to inserting the male tubular end 310 within the female tubular end 320). In an alternative embodiment, the swellable element 330 may be configured to be positioned within at least some portion of the female tubular end 320 prior to positioning the male tubular end 310 with respect to the female tubular end 320 (e.g., prior to inserting the male tubular end 310 within the female tubular end 320). In still another embodiment, the swellable element 330 may be configured to be positioned between the male tubular end 310 and the female tubular end 320 after the male tubular end 310 is positioned with respect to the female tubular end 320 (e.g., prior to inserting the male tubular end 310 within the female tubular end 320).

In the embodiment of FIG. 3C, swelling causes the swellable element 330 to contact and/or exert a force against the exterior surface 313 of the male tubular end 310 and the interior surface 323 of the female tubular end 320, thereby resulting in a frictional force between the swellable element 330 and the male tubular end 310 and the swellable element 330 and the female tubular end 320. In this embodiment, such a frictional force resists, impedes, or prohibits substantial movement of the swellable element 330 relative to the male tubular end 310 and of the swellable element 330 relative to the female tubular end 320. As such, the frictional force between the swellable element 330 and the male tubular end 310 and between the swellable element 330 and the female tubular end 320 may resist, impede or prohibit relative movement of the male tubular end 310 and the female tubular end 320. As such, the swellable element 330 may be employed to connect the male tubular end 310 to the female tubular end 320.

Additionally, in the embodiment of FIG. 3C the swollen swellable element 330 has expanded to fill, alternatively, to substantially fill the circumferential space 340. Thus, the interaction between flange 311, flange 321, and swellable element 330 resists movement of the male tubular end 310 with respect to the female tubular end 320 (e.g., resists and/or prevents the male tubular end 310 from being separated from the female tubular end 320).

In an embodiment, a swollen swellable element may be impermeable to fluid, alternatively, substantially impermeable to fluid. In such an embodiment, the swelling of the swellable element 330 to contact the exterior surface 313 of the male tubular end 310, the interior surface 323 of the female tubular end 320, or both results in a fluid-tight seal between the swellable element 330 and the male tubular end 310, the swellable element 330 and the female tubular end 320, or both. In an embodiment, the tubular connection system 300 thus provides a fluid-tight connection between the first tubular member 301 and the second tubular member 302.

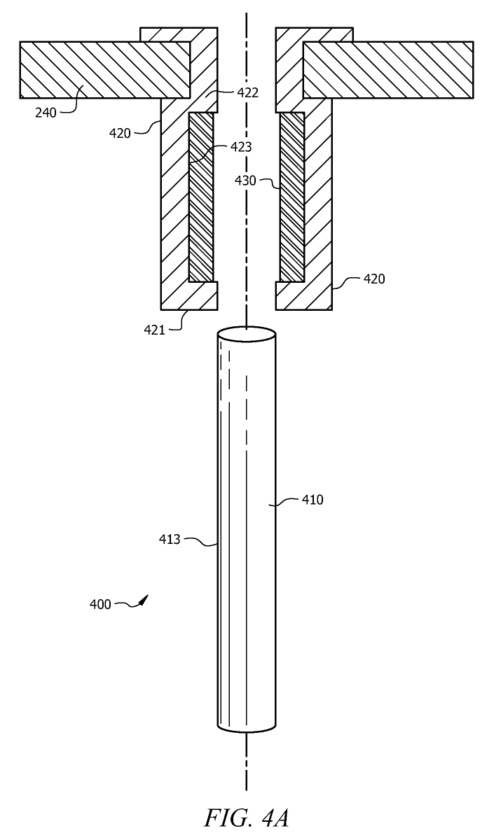

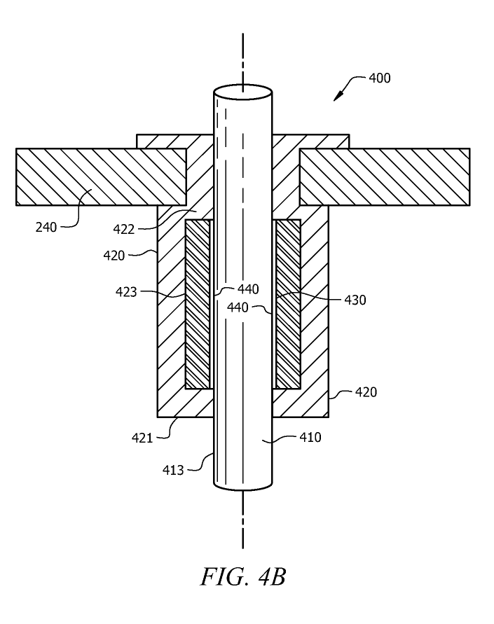

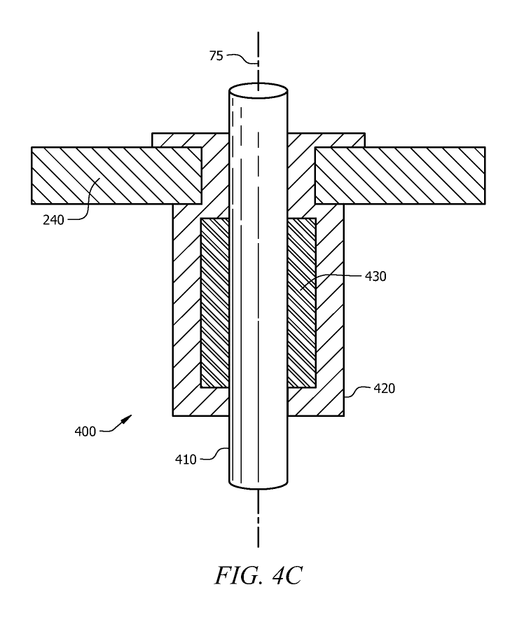

Referring now to FIGS. 4A, 4B, and 4C, in an embodiment, the connection system may comprise a platform connection system 400. In an embodiment, the platform connection system 400 generally forms a connection between a structural member (e.g., referenced herein as third tubular member or riser 410), and the platform 240. Examples of tubular members, such as the third tubular member 410, which may suitably be connected to the platform 240 via the platform connection system 400, were previously discussed herein with reference to the tubular connection system 300.

In the embodiment of FIGS. 4A, 4B, and 4C, the insertable component comprises the third tubular member 410. In the embodiment of FIGS. 4A, 4B, and 4C, the third tubular member 410 generally comprises a cylindrical body, the cylindrical body being defined by the walls of the tubular member. The third tubular member 410 may comprise an exterior surface 413, generally referring to the outer substantially cylindrical surface extending the length of the third tubular member. In an embodiment, the third tubular member 410 may comprise any suitable outside diameter, as will be discussed in greater detail herein.

In the embodiment of FIGS. 4A, 4B, and 4C, the receiving component comprises a platform and/or facility receiving collar 420. In an embodiment, the platform receiving collar 420 generally comprises a body having a bore extending there-through. In the embodiment of FIGS. 4A, 4B, and 4C, the platform receiving collar 420 comprises a substantially cylindrical shape. In an embodiment, the platform receiving collar is complementary to the structural member received thereby.

In an embodiment, the platform receiving collar 420 is coupled to the platform 240 via a means known to one of skill in the art (e.g., via welding or bolts). Alternatively, in an embodiment, the platform receiving collar 420 may comprise a part or component of the platform 240 (e.g., the platform receiving collar 420 may be integral with the platform or a component thereof).

In an embodiment, the platform receiving collar 420 comprises an interior surface 423, generally referring to the surface substantially defining the inner bore of the platform receiving collar 420.

In the embodiments of FIGS. 4A, 4B, and 4C, the platform receiving collar 420 is shown comprising an optional upper flange 422 and an optional lower flange 421, each of which generally comprises a shoulder raised above least a portion of the interior surface 423 of the platform receiving collar 420. When present, the flanges 421 and 422 may be attached to the platform receiving collar by any suitable means (e.g., a welded connection or threaded connection) or may be formed as an integral part of the platform receiving collar 420.

Referring to FIG. 4B, the third tubular member 410 is shown extending through the platform receiving collar 420. The third tubular member 410 may be complementary to the platform receiving collar 420 (e.g., such that the third tubular member 410 may be inserted within the platform receiving collar 420). In this embodiment, the circumferential space 440 is shown extending between a portion of the exterior surface 413 of the third tubular member 410 and the interior surface 423 of the platform receiving collar 420. Also shown in FIG. 4B, a swellable element 430 in its unswollen state is positioned within the circumferential space 440. Thus, as will be appreciated by one of skill in the art, in an embodiment the outside diameter of the third tubular member 410 (with reference to longitudinal axis 75) may be less than the inside diameter of the platform receiving collar 420. In an embodiment, the outside diameter of the third tubular member 410 (with reference to longitudinal axis 75) may be less than the inside diameter of the platform receiving collar 420 (with reference to longitudinal axis 75) alternatively, less than the inside diameter of the upper and lower flanges 421 and 422 (with reference to longitudinal axis 75). Further, in an embodiment the outside diameter of the third tubular member 410 with reference to longitudinal axis 75 is smaller than the inside diameter of the platform receiving collar 420 (with reference to longitudinal axis 75) (e.g. such that the unswollen swellable element 330 may be positioned within the circumferential space 440). Further still, in an embodiment the outside diameter of the third tubular member 410 (with reference to longitudinal axis 75) is smaller than the inside diameter of flanges 421 and 422 of the platform receiving collar 420 (e.g. such that the unswollen swellable element 430 may be positioned within the circumferential space 440).

As explained above with reference to FIGS. 3A, 3B, and 3C, in an embodiment the swellable element 430 may be configured to be positioned about at least some portion of the third tubular member 410 prior to positioning the third tubular member 410 with respect to the platform receiving collar 420 (e.g., prior to inserting the third tubular member 410 within the platform receiving collar 420). In an alternative embodiment, the swellable element 430 may be configured to be positioned within at least some portion of the platform receiving collar 420 prior to positioning the third tubular member 410 with respect to the platform receiving collar 420 (e.g., prior to inserting the third tubular member 410 within the platform receiving collar 420). In still another embodiment, the swellable element 430 may be configured to be positioned between the third tubular member 410 and the platform receiving collar 420 after the third tubular member 410 is positioned with respect to the platform receiving collar 420 (e.g., prior to inserting the third tubular member 410 within the platform receiving collar 420).

In the embodiment of FIG. 4C, swelling via contact with a swelling agent causes the swellable element 430 to contact and/or exert a force against the exterior surface 413 of the third tubular member 410 and the interior surface 423 of the platform receiving collar 420, thereby resulting in a frictional force between the swellable element 430 and the third tubular member 410, the platform receiving collar 420, or both. In this embodiment, such a frictional force resists, impedes, or prohibits substantial movement of the swellable element 430 relative to the third tubular member 410 and the platform receiving collar 420. As such, the swellable element 430 may be employed to connect the third tubular member 410 to the platform receiving collar 420.

As will be appreciated by one of skill in the art, it may be desirable to reduce the vibratory energy transferred between a platform and a tubular member. In an embodiment, the platform connection system 400 disclosed herein may be advantageously employed to dampen vibratory energy transferred from the platform 240 to the third tubular member 410 or vice versa. As discussed previously herein, the swellable element 430 may be characterized as comprising an elastic or rubbery material. As will be appreciated by one of skill in the art, because the connection is substantially via the swellable element 430, vibratory energy may be dampened or substantially dampened by the swellable element 430. Thus, in an embodiment, little or no vibratory energy will be transferred from the platform 240 to the third tubular member 410, or alternatively, from the third tubular member 410 to the platform 240.

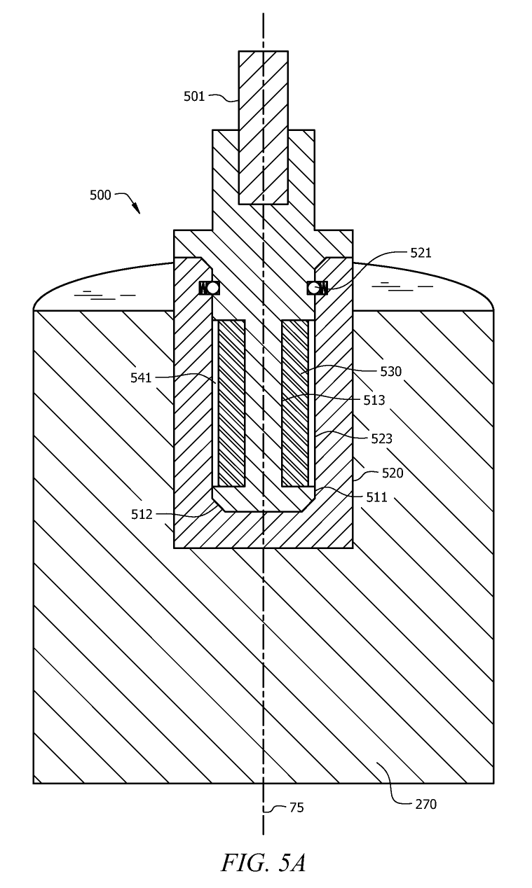

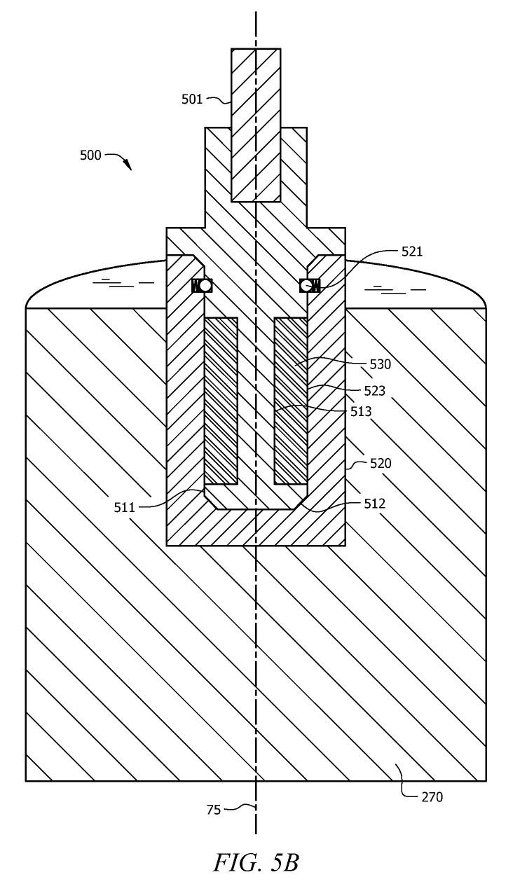

Referring now to FIGS. 5A and 5B, in an embodiment, the connection system comprises a tether connection system 500. In this embodiment, the tether connection system is employed to form a connection between a first tethering member 501 and an anchor (e.g., referenced herein as a suction pile 270). In alternative embodiments, a tether connection system like tether connection system 500 may be employed to form a connection between two or more tethering members, or between a tethering member and a platform, an anchoring device, or the like. One of skill in the art will appreciate other suitable uses for a tether connection system.

In the embodiment of FIGS. 5A and 5B, the insertable component comprises a male tether end 510. As similarly discussed with respect to the tubular connection system 300, the male tether end 510 may be configured (e.g., sized and shaped) to be inserted with the receiving component. In the embodiment of FIGS. 5A and 5B, the male tether end 510 may be generally cylindrical. The male tether end 510 may comprise an exterior surface 513, generally referring to the outer substantially cylindrical surface extending the length of the male tether end 510.

In the embodiments of FIGS. 5A and 5B, the male tether end 510 comprises a segment of the first tethering member 501. In such an embodiment, the male tether end 510 may be manufactured in conjunction with the first tethering member 501 or formed from a segment of the first tethering member 501. In an alternative embodiment, a male tether end 510 comprises a separate unit of manufacture which may be joined to the first tethering member 501 by any suitable means which will be known to one of skill in the art (e.g., as by a threaded connection, a welded connection, a composite connection, or combinations thereof). In still other alternative embodiments, a male tether end like male tether end 510 may be coupled to a suction pile or other anchoring device, a platform, or the like. For example, both ends of the tether may comprise a connection system 500, with one end connected to an anchor (e.g., suction pile 270) and the other end connected to the platform 240 or a component thereof. As disclosed with reference to the embodiments of FIGS. 3A, 3B, and 3C, in an embodiment, the male tether end 510 comprises an optional collar or flange, referred to herein as flange 511. Also, as disclosed with reference to the embodiments of FIGS. 3A, 3B, and 3C, in an embodiment, the male tether end 510 comprises an optional beveled edge, referred to herein as beveled edge 512.

In the embodiment of FIGS. 5A and 5B, the receiving component comprises a female tether end 520. As similarly discussed with respect to the tubular connection system 300, the female tether end 520 may be configured (e.g., sized and shaped) to receive the insertable component (e.g., the male tether end 510). In the embodiment of FIGS. 5A and 5B, the female tether end 520 may be generally cylindrical. The female tether end 520 may comprise an interior surface 523, generally referring to the surface substantially defining the elongated inner bore of the female tether end 520.

In the embodiment of FIGS. 5A and 5B, the female tether end 520 is coupled to suction pile 270. In alternative embodiments, as will be appreciated by one of skill in the art with the aid of this disclosure, a female tether end like female tether end 520 may be coupled to a platform, an anchoring device, a tethering member, or the like. As disclosed with reference to the embodiments of FIGS. 3A, 3B, and 3C, in an embodiment, the female tether end 520 comprises an optional collar or flange, referred to herein as flange 521.

Referring now to FIG. 5A, the male tether end 510 is shown positioned within the female tether end 520. The male tether end 510 may be complementary to the female tether end 520 (e.g., such that the male tether end 510 may be inserted within the female tether end 520). In this embodiment, a circumferential space 540 is shown extending between the exterior surface 513 of the male tether end 510 and the interior surface 523 of the female tether end 520. Also shown in FIG. 5A, a swellable element 530 in its unswollen state is positioned within the circumferential space 540. Thus, as will be appreciated by one of skill in the art, in an embodiment the outside diameter of the male tether end 510 (with reference to longitudinal axis 75) may be less than the inside diameter of the female tether end 520 (with reference to longitudinal axis 75). Further, in an embodiment the outside diameter of the male tether end 510 (with reference to longitudinal axis 75 is smaller than the inside diameter of the female tether end 520 (e.g. such that the unswollen swellable element 530 may be positioned within the circumferential space 540). Further, in an embodiment the outside diameter of the male tether end 510 is smaller than the inside diameter of the female tether end 520 (e.g. such that the unswollen swellable element 530 may be positioned within the circumferential space 540). Further still, in an embodiment the outside diameter of the flange 511 of the male tether end 510 is smaller than the inside diameter of the flange 521 of the female tether end 520 (e.g. such that the unswollen swellable element 530 may be positioned within the circumferential space 540).

As explained above with reference to FIGS. 3A, 3B, and 3C, in an embodiment the swellable element 530 may be configured to be positioned about at least some portion of the male tether end 510 prior to positioning the male tether end 510 with respect to the female tether end 520 (e.g., prior to inserting the male tether end 510 within the female tether end 520). In an alternative embodiment, the swellable element 530 may be configured to be positioned within at least some portion of the female tether end 520 prior to positioning the male tether end 510 with respect to the female tether end 520 (e.g., prior to inserting the male tether end 510 within the female tether end 520). In still another embodiment, the swellable element 530 may be configured to be positioned between the male tether end 510 and the female tether end 520 after the male tether end 510 is positioned with respect to the female tether end 520 (e.g., prior to inserting the male tether end 510 within the female tether end 520).

In the embodiment of FIG. 5B, as was similarly discussed above, swelling causes the swellable element 530 to contact and/or exert a force against the exterior surface 513 of the male tether end 510 and the interior surface 523 of the female tether end 520, thereby resulting in a frictional force between the swellable element 530 and the male tether end 510, the female tether end 520, or both. In this embodiment, such a frictional force resists, impedes, or prohibits substantial movement of the swellable element 530 relative to the male tether end 510, the female tether end 520, or both. As such, the swellable element 530 may be employed to connect the male tether end 510 to the female tether end 520.

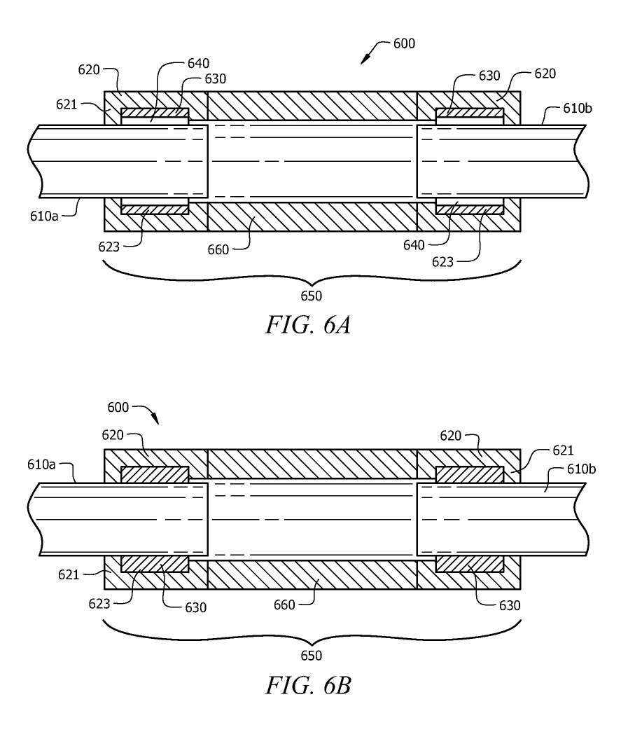

Referring now to FIGS. 6A and 6B, in an embodiment, the connection system may comprise a tubular repair system 600. In an embodiment, the repair system 600 generally forms a connection between a structural member, such as fourth tubular member 610, and a repair apparatus, such as repair apparatus 650. Nonlimiting examples of tubular members which may be suitably repaired with such a tubular repair system were previously discussed herein.

In the embodiment of FIGS. 6A and 6B, the insertable component comprises the ends of the fourth tubular member 610a and/or 610b or a similar such tubular member having been previously described herein. In an embodiment, where a tubular member, e.g., the fourth tubular member 610 or a portion thereof, has become damaged or the its integrity has been compromised, the damaged or compromised portion of the fourth tubular member 610 may be removed, leaving two ends of the fourth tubular member 610a and 610b.

In the embodiment of FIGS. 6A and 6B, the receiving component comprises a sealing collar 620. The sealing collar 620 may be configured to be positioned about at least a portion of a tubular member, such as the ends of the fourth tubular member 610a and/or 610b. In an embodiment, a bore extends through the sealing collar 620. In the embodiment of FIGS. 6A and 6B, the repair collar 620 comprises a substantially ring-like shape.

In an embodiment, the sealing collars 620 comprise an interior surface 623, generally referring to the surface substantially defining the inner bore of the sealing collar 620. As discussed previously herein, in an embodiment the sealing collar 620 may comprise one or more optional flanges 621. As similarly discussed herein, when present the flanges 621 may be employed to restrict or prevent movement of the sealing collar 620 relative to the ends of the fourth tubular member 610a and/or 610b and/or to hold the swellable element 630 in place with respect to the sealing collar 620, the fourth tubular member 610, or both. When present, the flanges 621 and the interior surface 623 may define a substantially u-shaped channel.

In the embodiment of FIGS. 6A and 6B, the repair apparatus 650 comprises two sealing collars 620, which may be located at opposing ends of the repair apparatus 650. In this embodiment, the repair apparatus 650 further comprises a sleeve 660 extending between the two sealing collars 620 and sealingly connecting two ends of the fourth tubular member 610a and 610b. The sleeve may comprise any suitable material. In various embodiments, the sleeve 660 may be characterized as flexible or rigid and/or extendable or contractible. In alternative embodiments, a repair apparatus may comprise a single sealing collar or multiple sealing collars but no sleeve.

Referring to FIG. 6A, the ends of the fourth tubular member 610a and 610b are shown positioned within the sealing collars 620. The ends of the fourth tubular member 610a and 610b may be complementary to the sealing collars 620 (e.g., such that the ends of the fourth tubular member 610a and 610b may be inserted within the sealing collars 620). In this embodiment, the circumferential space 640 is shown extending between a portion of the exterior surface 613 of the ends of the fourth tubular member 610a and 610b and the interior surface 623 of the sealing collar 620. Also shown in FIG. 6A, a swellable element 630 in its unswollen state is positioned within the circumferential space 640. Thus, as will be appreciated by one of skill in the art, in an embodiment the outside diameter of the ends of the fourth tubular member 610a and 610b (with reference to longitudinal axis 75) may be less than the inside diameter of the sealing collar 620. In an embodiment, the outside diameter of the ends of the fourth tubular member 610a and 610b (with reference to longitudinal axis 75) may be less than the inside diameter of the sealing collar 620 (with reference to longitudinal axis 75) alternatively, less than the inside diameter of the flanges 621 (with reference to longitudinal axis 75). Further, in an embodiment the outside diameter of the ends of the fourth tubular member 610a and 610b (with reference to longitudinal axis 75) is smaller than the inside diameter of the sealing collar 620 (with reference to longitudinal axis 75) (e.g. such that the unswollen swellable element 630 may be positioned within the circumferential space 640). Further still, in an embodiment the outside diameter of the ends of the fourth tubular member 610a and 610b (with reference to longitudinal axis 75) is smaller than the inside diameter of flanges 621 of the sealing collar 620 (e.g. such that the unswollen swellable element 630 may be positioned within the circumferential space 640).

As discussed previously herein with respect to other embodiments, in the embodiment of FIG. 6B the swollen swellable element 630 may be employed to resist, impede, or prohibit relative movement of the ends of the fourth tubular member 610a and 610b and the sealing collars 620. As such, the swellable element 630 may be employed to connect one or both of the ends of the fourth tubular member 610a and/or 610b to the one or more sealing collars 620. In the embodiment of FIG. 6B, the swellable element 630 may be employed to form a fluid-tight connection, alternatively, a substantially fluid-tight connection, between the ends of the fourth tubular member 610a and 610b and the one or more sealing collars 620.

As explained above with reference to FIGS. 3A, 3B, and 3C, in an embodiment the swellable element 630 may be configured to be positioned about at least some portion of the ends of the fourth tubular member 610a and 610b prior to positioning the ends of the fourth tubular member 610a and 610b with respect to the sealing collars 620 (e.g., prior to inserting the ends of the fourth tubular member 610a and 610b within the sealing collars 620). In an alternative embodiment, the swellable element 630 may be configured to be positioned within at least some portion of the sealing collars 620 prior to positioning the ends of the fourth tubular member 610a and 610b with respect to the sealing collars 620 (e.g., prior to inserting the ends of the fourth tubular member 610a and 610b within the sealing collars 620). In still another embodiment, the swellable element 630 may be configured to be positioned between the ends of the fourth tubular member 610a and 610b and the sealing collars 620 after the ends of the fourth tubular member 610a and 610b are positioned with respect to the female tether end 520 (e.g., prior to inserting the ends of the fourth tubular member 610a and 610b within the sealing collars 620).

In an embodiment, a method of making a connection generally comprises inserting a an insertable component within receiving component to thereby form a circumferential space, positioning a swellable element within the circumferential space, contacting the swellable element to the swelling agent, and allowing the swellable element to swell (e.g., expand), thereby forming a connection due to the friction between the insertable component and the receiving component via the swellable element.

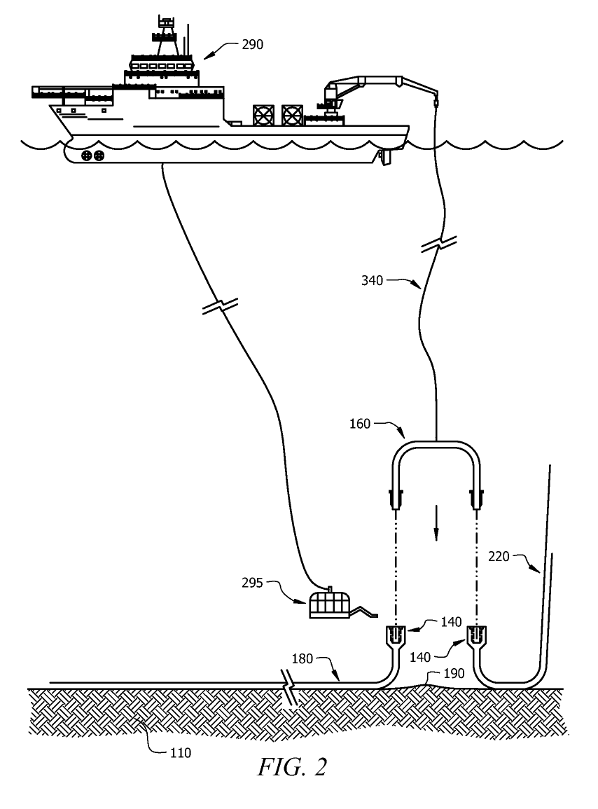

Referring to FIGS. 2, 3A, 3B, and 3C, an embodiment of a method of making a connection 200 is shown. Although this embodiment illustrates a method of making a connection with respect to a connection between two tubular members, it should be noted that the method illustrated may be generally applicable to methods of making a connection between various other subsea hydrocarbon production equipment members and the various embodiments of connection systems (e.g., FIGS. 1, and 3-6) such as those previously disclosed herein.

In an embodiment, the method of making a connection 200 initiates with positioning the second tubular member 302. Positioning the second tubular member 302 may comprise lowering the second tubular member 302 from a support vessel 290 via a deployment cable 291. Positioning the second tubular member 302 may further comprise employing a remotely operated vehicle (ROV) 295, the operation of which will be known to one of skill in the art. In the embodiment of FIG. 2, the second tubular member 302 comprises and/or is coupled to a receiving component (e.g., the female tubular end 320). In an alternative embodiment, a second tubular member may comprise or be coupled to an insertable component (such as male tubular end 310).

In an embodiment, the method of making a connection 200 further comprises positioning an insertable component within a receiving component, alternatively, positioning a receiving component about an insertable component. In the embodiment of FIG. 2, 3A, 3B, and 3C, the first tubing member 301 comprises an insertable component (e.g., the male tubular end 310). Alternatively, in an embodiment where a second tubular member comprises or is coupled to an insertable component (e.g. such as male tubular end 310), a second tubing member may comprise or be coupled to a receiving component (e.g., such as female tubular end 320). In an embodiment, the first tubing member 301 is positioned with respect to the second tubing member 302 such that the insertable component or a portion thereof is positioned within the receiving component or a portion thereof.

Referring to FIGS. 3A, 3B, and 3C sequentially, the insertable component (e.g., the male tubular end 310) is shown being positioned within the receiving component (e.g., the female tubular end 320). In this embodiment, as referenced herein above, the male tubular end 310 comprises an optional beveled edge 312 and the female tubular end comprises an optional beveled edge 322). Where present, the beveled edge 312, 322, or both may aid in positioning the male tubular end 310 with respect to the female tubular end 320. For example, as the male tubular end 310 is inserted within the female tubular end 320, alternatively, as the female tubular end is position around the male tubular end 310, the beveled edge 312, 322, or both may operate to guide the male tubular end 310 into the female tubular end 320 and/or to guide the female tubular end 320 over the male tubular end 310.

In an embodiment, the repair apparatus 650 may be employed to repair a tubular member. In an embodiment where the fourth tubular member has been damaged (e.g., so as to result in a leak, a fracture, or the like), the repair apparatus 650 may be employed. A method of deploying the repair apparatus 650 to repair the fourth tubular member 610 may generally comprise removing the damaged or compromised portion of the fourth tubular member 610, thereby leaving two unconnected ends 610a and 610b. After the damaged or compromised portion has been removed, the repair apparatus 650 may be positioned with respect to the two ends of the fourth tubular member 610a and 610b (e.g., a first sealing collar 620 may be positioned about at least a portion of one end of the fourth tubular member (either 610a or 610b) and a second sealing collar 620 may be positioned about at least a portion of the other end of the fourth tubular member (the other of 610a or 610b). In an embodiment, the sleeve 660 may be flexible, extendable, contractible, or combinations thereof so as to assist in placement of the repair apparatus with respect to the ends of the fourth tubular member 610a and/or 610b.

In an alternative embodiment, the receiving component may be “wrapped” around the insertable component. For example, the receiving component may comprise a hinged or “clam-shell” like mechanism configured to be positioned about the insertable component. Particularly, it is contemplated that such an embodiment may be advantageously employed in conjunction with a repair apparatus like repair apparatus 650, for example, one or more hinges or joints extending longitudinally along sealing collars 620 and/or sleeve 660. Alternatively, the receiving component may comprise multiple pieces which may be joined together around the insertable component. As such, a repair apparatus might be positioned around or about a portion of a tubular without needing the slide that repair apparatus over some length of tubular adjacent to that portion of the tubular. Additional means of positioning a receiving component about an insertable component will be appreciated by one of skill in the art with the aid of this disclosure.

In an embodiment, the method of making a connection 200 comprises positioning a swellable element (e.g., swellable element 330) within the circumferential space. In an embodiment, the swellable element may be positioned within the receiving component prior to positioning the insertable component with respect thereto. For example, referring to the embodiment of FIGS. 3A, 3B, and 3C, the swellable element 330 is placed around the male tubular end 310 prior to positioning the male tubular end 310 within the female tubular end 320. In an embodiment, a swellable element (e.g., swellable element 330) may be integral with the insertable component (e.g., the male tubular end 310).

Alternatively, in an embodiment the swellable element may be positioned within the receiving component prior to positioning the insertable component with respect thereto. For example, referring to the embodiment of FIGS. 4A, 4B, and 4C the swellable element 430 is placed within the platform receiving collar 420 (i.e., the receiving component) prior to inserting the third tubular member 410 therethrough. In an embodiment, a swellable element (e.g., swellable element 330) may be integral with the receiving component (e.g., the female tubular end 420).

Alternatively, in still another embodiment, the insertable component may be positioned with respect to the receiving component prior to placing the swellable element therebetween. In such an embodiment, the swellable element may be placed within the circumferential space after the insertable component has been positioned with respect to the receiving component.

In an embodiment, the method of making a connection 200 comprises exposing the swellable element 330 to the swelling agent and allowing the swellable element 330 to swell (e.g., expand). In an embodiment the swellable element 330 will continue to be exposed to the swelling agent until swelling is complete, for some amount of time after contact with the swelling agent, or indefinitely.

In an embodiment, exposing the swellable element 330 to a swelling agent may comprise submerging the swellable element in the swelling agent. For example, in the embodiment of FIGS. 2, 3A, 3B, and 3C (as well as other embodiments disclosed herein), the swelling agent may comprise water (e.g., freshwater or saltwater). As such, the swellable element 330 may begin to swell upon being submerged in the body of water 260. Alternatively, in an embodiment exposing the swellable element 330 may comprise providing swelling agent via the interior flowbore of a tubular member.

As discussed above, in an embodiment the swellable element 330 may swell, alternatively, begin to swell, upon exposure to the swelling agent. In an embodiment, swelling may begin upon exposure of the swellable element 330 to the swelling agent and continue for some period of time thereafter. For example, the swellable element 330 may continue to swell for about 1 hour following exposure or continued exposure to a swelling agent, alternatively, 2, 3, 4, 5, 6, 12, 18, 24, 36, 48, 96, 192, 384, 768 or more hours following exposure or continued exposure to a swelling agent.

In an embodiment, it may be desirable to slow or delay the swelling of a swellable element 330 until the swellable element 330 has been positioned with respect to an insertable component, a receiving component, or both. In an additional embodiment, the swelling of the swellable element 330 may be delayed by providing a protective sheath which will disallow contact of the swellable element 330 with the swelling agent. In such an embodiment, the protective sheath may prevent or lessen swelling of the swellable element 330 until the swellable element 330 is brought into contact with the swelling agent upon removal of the protective sheath and/or penetration or permeation of the protective sheath by the swelling agent. Such a sheath may be readily envisaged by one of skill in the art upon viewing this disclosure.

In an embodiment, the method of making a connection 200 may further comprise allowing the swellable element 330 to remain in contact with the swelling agent. For example, in an embodiment where the swellable element is reversibly swellable, it may desirable for the swelling agent to remain in contact with the swellable element 330 such that the swelling of the swellable element 330 is not reversed. In an embodiment where the swelling agent comprises a substantially aqueous fluid (e.g., sea water), continued contact with the swelling agent may be provided via the body of water 260. Alternatively, in an embodiment where the swelling agent comprises a hydrocarbon, continued contact with the swelling agent may be provided by a hydrocarbon produced from the subterranean formation 110 and flowing through the flowbore of the tubular.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural or other details supplementary to the disclosure.

What is claimed is:

1. A method of making a connection in hydrocarbon production equipment comprising:
positioning at least a portion of a receiving component about at least a portion of an insertable component;
providing a swellable element within a circumferential space substantially defined by the at least a portion of the receiving component and the at least a portion the insertable component; and
allowing the swellable element to expand.

2. The method of claim 1, wherein the swellable element contacts the receiving component, the insertable component, or both upon expansion of the swellable element.

3. The method of claim 2, wherein a substantially fluid-tight seal between the receiving component and the insertable component is formed upon expansion of the swellable element.

4. The method of claim 1, wherein the swellable element expands via contacting with a swelling agent.

5. The method of claim 4, wherein the swelling agent comprises a substantially aqueous fluid, a hydrocarbon, or combinations thereof.

6. The method of claim 5, wherein the swellable element comprises a natural rubber, an elastomeric material, a styrofoam bead, a polymeric beads, or combinations thereof.

7. The method of claim 6, wherein the elastomeric material comprises a styrene-butadiene copolymer, a neoprene, a synthetic rubber, a vinyl plastisol thermoplastic, or combinations thereof.

8. The method of claim 1, wherein the receiving component, the insertable component, or both is coupled to a subsea hydrocarbon production equipment member, an offshore platform, or combinations thereof.

9. The method of claim 8, wherein the subsea hydrocarbon production equipment member comprises a tubular member, a riser, a wellhead, a valve, a pipeline, a flow conduit, a collar, a joint, a connection, a fitting, a spool, a template, a manifold, an instrument, a gauge, or combinations thereof.

10. The method of claim 1, wherein the insertable component comprises a tubular member, a riser, a pipeline, a flow conduit, or combinations thereof, and wherein the receiving component comprises a collar coupled to an offshore platform.

11. The method of claim 1, wherein the receiving component, the insertable component, or both is coupled to a tethering member, a cable, an anchoring device, an offshore platform, or combinations thereof.

12. The method of claim 1, wherein the insertable component comprises a tubular member, a riser, a pipeline, a flow conduit, or combinations thereof, and wherein the receiving component comprises a collar coupled to a sleeve.

13. A hydrocarbon production equipment apparatus comprising:
an insertable component positioned within a receiving component; and
a swellable element positioned between at least a portion of the insertable component and at least a portion of the receiving component, wherein the insertable component, the receiving component, or both is coupled to a hydrocarbon production equipment member,
wherein the swellable element swells in response to contact with a swelling agent.

14. The hydrocarbon production equipment apparatus of claim 13, wherein the swellable element comprises a natural rubber, an elastomeric material, a styrofoam bead, a polymeric bead, or combinations thereof.

15. The hydrocarbon production equipment apparatus of claim 14, wherein the elastomeric material comprises a styrene-butadiene copolymer, a neoprene, a synthetic rubber, a vinyl plastisol thermoplastic, or combinations thereof.

16. The hydrocarbon production equipment apparatus of claim 13, wherein the swelling agent comprises a substantially aqueous fluid, a hydrocarbon, or combinations thereof.

17. The hydrocarbon production equipment apparatus of claim 13, wherein hydrocarbon production equipment member is offshore.

18. The hydrocarbon production equipment apparatus of claim 13, wherein hydrocarbon production equipment member is subsea.

19. The subsea hydrocarbon production equipment apparatus of claim 17, wherein the subsea hydrocarbon production equipment member comprises a tubular member, a riser, a wellhead, a valve, a pipeline, a flow conduit, a collar, a joint, a connection, a fitting, a spool, a template, a manifold, an instrument, a gauge, or combinations thereof.

20. A hydrocarbon production equipment apparatus comprising:
a first collar positioned about a first tubular member;
a second collar configured to be positioned about a second tubular member, the second tubular member generally coaxially aligned with the first tubular member and spaced apart from the first tubular member to form a gap between the first and second tubular members;
a first swellable element positioned between at least a portion of the first tubular member and at least a portion of the first collar, wherein the first swellable element contacts the first collar and the first tubular member upon contact with a swelling agent;
a second swellable element positioned between at least a portion of the second tubular member and at least a portion of the second collar, wherein the second swellable element contacts the second collar and the second tubular member upon contact with the swelling agent; and
a sleeve coupled to the first collar and the second collar and enclosing the gap between the first and second tubular members.

21. The hydrocarbon production equipment apparatus of claim 20, wherein the first swellable element and the second swellable element comprise a natural rubber, an elastomeric material, a styrofoam bead, a polymeric bead, or combinations thereof.

22. The hydrocarbon production equipment apparatus of claim 21, wherein the elastomeric material comprises a styrene-butadiene copolymer, a neoprene, a synthetic rubber, a vinyl plastisol thermoplastic, or combinations thereof.

23. A hydrocarbon production equipment apparatus wherein the first tubular member, the second tubular member, the first swellable element, the second swellable element, and the sleeve are located subsea.
